(19) United States
(12) Patent Application Publication
(10) Pub. No.: US 2015/0193186 A1
(43) Pub. Date: Jul. 9, 2015

(54) METHOD AND APPARATUS FOR SUPPLYING IMAGE

(71) Applicant: Samsung Electronics Co., Ltd., Gyeonggi-do (KR)

(72) Inventors: Kyung-Tak Lee, Gyeonggi-do (KR); Je-Young Maeng, Gyeonggi-do (KR); Gyu-Bong Oh, Gyeonggi-do (KR)

(21) Appl. No.: 14/412,896

(22) PCT Filed: Jul. 3, 2013
(86) PCT No.: PCT/KR2013/005901

§ 371 Date: Jan. 5, 2015

(30) Foreign Application Priority Data
Jul. 3, 2012 (KR) 10-2012-0072058

(51) Int. Cl. G06F 3/14

(52) U.S. Cl. CPC G06F 3/1438; G09G 2340/145

(57) ABSTRACT

Disclosed is a system for automatically adjusting a received view according to mutual positions and view points of image reproducing devices by using the plurality of image reproducing devices and displaying the adjusted view. The view is adjusted without a necessity of manually selecting the view by a user, thereby improving usage convenience, and one scene (for example, a concert hall) is displayed in accordance with view points of several devices at the same time, thereby improving a sense of realism.

### TECHNICAL FIELD

The present invention relates to a system for providing an image through a plurality of devices, and more particularly, to a method and an apparatus for providing an image related to one subject through a plurality of devices corresponding to respective plural viewing angles.

### BACKGROUND ART

When a user views multimedia contents, such as live broadcasting or a movie, surround sound technology (for example, a 5.1 channel system) is introduced in a voice field, thereby providing a user with a more realistic effect even in a home environment, than an existing monophonic system. Various technologies, such as 3D technology, have been introduced even in an image field in order to provide a user with a more immersive experience.

An image is generally and mainly displayed using one screen, but an interest in multiscreen image services, which simultaneously utilize a plurality of screens, has been increased. Telepresence conference services attract many interests in a business environment. This provides an effect that participants located at remote places feel as if the participants are located at the same place through two or more large screens.

Since it is difficult to equip a large multiscreen environment, such as a system for providing the telepresence conference services, there is provided a method of reproducing contents stored in a smart phone or a tablet personal computer through a television by connecting the smart phone or the tablet personal computer to the television. However, according to an improvement of performance and an increase in sizes of screens of personal devices, such as a smart phone and a tablet PC, it is more convenient to enjoy multimedia contents, such as an image or a video.

### DISCLOSURE OF INVENTION

### Technical Problem

Accordingly, multiscreen image services capable of simultaneously using image reproducing devices, such as a television, a tablet PC, a television, and a smart phone even in a home environment has been demanded.

### Solution to Problem

Accordingly, an aspect of the present invention is to provide a method and an apparatus capable of simultaneously displaying one piece of multimedia content by using a plurality of image reproducing devices.

In accordance with an aspect of the present invention, a method of providing an image through a plurality of image reproducing devices by a control point device is provided. The method includes; collecting view point information from the plurality of image reproducing devices; recognizing a position of each of the plurality of image reproducing devices based on the view point information, and determining a corresponding renderer view and a corresponding divided image of a whole image to be provided in correspondence with the position of each of the plurality of image reproducing devices; and providing the corresponding divided image corresponding to the corresponding renderer view to each of the plurality of image reproducing devices.

### Advantageous Effects of Invention

As described below, the present invention is a system for automatically adjusting a received view according to mutual positions and view points of image reproducing devices by using the plurality of image reproducing devices and displaying the adjusted view. The view is adjusted without a necessity of manually selecting the view by the user, thereby improving usage convenience, and one scene (for example, a concert hall) is displayed in accordance with view points of several devices at the same time, thereby improving a sense of realism.

The present invention may simultaneously provide one multimedia content by using a plurality of image reproducing devices. The present invention is a system for automatically adjusting a view according to mutual positions and view points of devices by using the plurality of devices and displaying the view. The view is adjusted without a necessity of manually selecting the view by the user, thereby improving usage convenience, and one scene (for example, a concert hall) is displayed in accordance with view points of several devices at the same time, thereby improving a sense of realism.

### BRIEF DESCRIPTION OF DRAWINGS

The above and other aspects, features, and advantages of the present invention will be more apparent from the following detailed description taken in conjunction with the accompanying drawings, in which:

FIG. 1 is a diagram illustrating a configuration of an image reproducing device according to an embodiment of the present invention;

FIG. 2 is a diagram illustrating an example of a Universal Plug and Play (UPnP) to which the present invention is applied;

FIG. 3 is a diagram illustrating an operation process of the UPnP system;

FIG. 4 is a diagram illustrating left and right angles of a view according to an embodiment of the present invention;

FIG. 5 is a diagram illustrating a boundary of a view according to an embodiment of the present invention;

FIG. 6 is a diagram illustrating a display state of a plurality of image devices according to an embodiment of the present invention;

FIGS. 7 and 8 are diagrams illustrating an operation process of a multiscreen image system according to an embodiment of the present invention; and

FIG. 9 is a diagram illustrating an operation process of a control point device according to an embodiment of the present invention.

### MODE FOR THE INVENTION

Hereinafter, an embodiment according to the present invention will be described with reference to the accompanying drawings in detail. In the following description, the same elements will be designated by the same reference numerals although they are shown in different drawings. Further, in the description of the present invention, a detailed explanation of known related functions and constitutions may be omitted when it is determined to unnecessarily make the subject matter of the present invention obscure.

The present invention relates to a system and a method of displaying a multimedia content through a plurality of devices. Particularly, the present invention provides an image content which can be divided based on a plurality of viewing angles (hereinafter, referred to as a “multi-view”) or positions of a plurality of image reproducing devices through the plurality of image reproducing devices, rather than through one device screen. That is, the present invention simultaneously displays a multi-view image through a plurality of devices by recognizing a relative position of each of the plurality of devices, and automatically transmitting an image corresponding to each of a plurality of views to a device in accordance with a corresponding position. Hereinafter, a system for providing the aforementioned service is referred to as a multiscreen image system.

In the present invention, the service for providing the multi-view image may mean a service for providing a plurality of views so that a user may view an image at a desired angle by dividing an image into two or more images according to various viewing angles.

In the present invention, the service for providing the multi-view image may mean a service for providing a plurality of views so that a user may view an image at a desired angle by photographing a place at various viewing angles when photographing the place. For example, in a case where a certain concert is photographed in multi-views, the service may provide a multi-view image so that a user may see stands at the left side and the right side and enjoy an environment atmosphere, as well as an image of a center stage of the concert, by photographing the concert at a left side, a center, and a right side, that is, three views.

When a user has one screen, the viewer may select, and view an image corresponding to one view among multi-view images and view an image corresponding to a nonselected view in an additional form of a thumbnail.

When a user views the multi-view images through one screen, only an image corresponding to one view with an original size is selected and displayed, or images corresponding to two or more views are displayed on divided regions of one screen. However, it is more preferable to enable a user to view images corresponding to the multi-views through a plurality of screens as described in the present invention.

However, in a case of a plurality of screens, it is preferable to consider a relative position between the respective images corresponding to the plurality of views. For example, when a concert image is divided based on three left, center, and right views, screens are arranged at three left, center, and right screen positions, and a left screen displays a left-view image, a center screen displays a center-view image, and a right screen displays a right-view image, a position of each view is matched to a screen position. Accordingly, a user may more conveniently view a multimedia content, and feel a sense of realism as if the user is located in the concert according to a screen system environment.

Further, when the screen position is changed, it is necessary to change the view displayed through the screen to maintain a position matching. For example, a scenario, in which an image is divided based on three left, center, and right views, and screens are a television and a tablet PC, a user views a center view with the television, and views a right view or a left view with the tablet PC, may be considered. In this case, when the tablet PC automatically displays the right view in a case where the tablet PC is positioned at a right side of the television, and the tablet PC automatically displays the left view in a case where the tablet PC is positioned at a left side of the television, a position of the image view may be always matched with the view of the tablet PC.

In order to solve the aforementioned scenarios, the present invention provides a method of automatically matching positions of image views to be displayed with relative positions of receiving system screens.

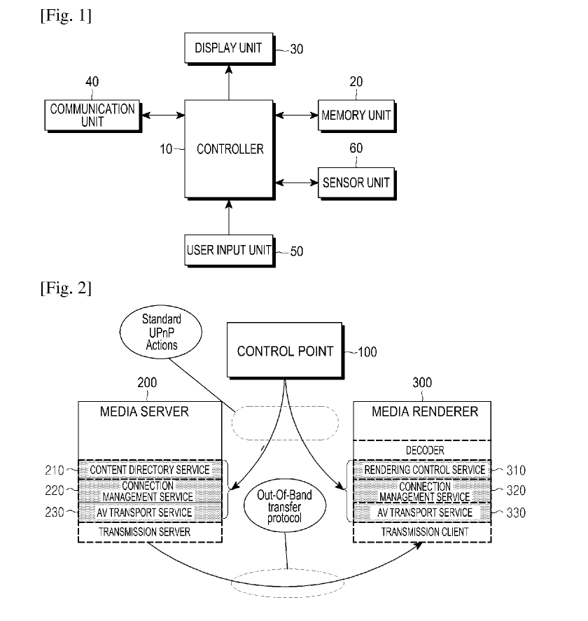

First, an example of an image reproducing device included in a multiscreen image system according to the present invention will be described with reference to FIG. 1. FIG. 1 is a diagram illustrating a configuration of the image reproducing device according to an embodiment of the present invention. The image reproducing device, which is a device capable of displaying an image, may include a television, a tablet PC, a smart phone, or the like.

Referring to FIG. 1, the image reproducing device includes a controller 10, a memory unit 20, a display unit 30, a communication unit 40, a user input unit 50, and a sensor unit 60.

The controller 10 controls a general operation of an image reproducing device, and thus controls the memory unit 20, the display unit 30, the communication unit 40, the user input unit 50, and the sensor unit 60. Particularly, the image reproducing device is operated as any one of a control point 100, a media server 200, and a media renderer 300 according to the present invention, and the image reproducing device controls an operation of each constitutional unit of the image reproducing device according to each role.

The memory unit 20 may store signals or data input/output in correspondence with operations of the display unit 30, the communication unit 40, the user input unit 50, and the sensor unit 60 according to a control of the controller 10. The memory unit 20 may store control programs or applications for the control of the image reproducing device or the controller 10.

A term, “memory unit”, includes a storage unit, a ROM, a RAM, or a memory card (not shown) (for example, an SD card or a memory stick) mounted on the image reproducing device. The memory unit may include a non-volatile memory, a volatile memory, a Hard Disk Drive (HDD), or a Solid State Drive (SSD).

The display unit 30 displays an image under the control of the controller 10.

The communication unit 40 includes at least one of a cellular communication module and a sub communication module. The cellular communication module permits the image reproducing device to be connected with an external device through a mobile communication network by using at least one antenna (not shown) according to the control of the controller 10. The cellular communication module transceives a wireless signal for a voice call, a video call, a Short Message Service (SMS), or a Multimedia Messaging Service (MMS) with a portable phone (not shown), a smart phone (not shown), a tablet PC, or another device (not shown) having a telephone number.

The sub communication module may include at least one of a wireless LAN module and a near field communication module. For example, the sub communication module may include only the wireless LAN module, only the radio field communication module, or both the wireless LAN module and the radio field communication module.

The wireless LAN module may be connected to the Internet at a place at which a wireless Access Point (AP) is installed according to the control of the controller 10. The wireless LAN module supports the wireless LAN standard (IEEE802.11x) of the Institute of Electrical and Electronics Engineers (IEEE). The near field communication module may wirelessly perform near field communication between the image reproducing device 10 and another device according to the control of the controller 10. The near field communication method may include Bluetooth, infrared communication (Infrared Data Association; IrDA), or the like.

The user input unit 50 receives input data from a user and transmits the received input data to the controller 10. The user input unit 50 may include at least one of, for example, a plurality of keys, a touch screen, a key pad, and a microphone.

The sensor unit 60 includes at least one sensor detecting a state of the image reproducing device. For example, the sensor unit 60 may include a proximity sensor for detecting an approach to the image reproducing device 10, a luminance sensor for detecting a quantity of light around the image reproducing device, or a motion sensor for detecting an operation of the image reproducing device (for example, a rotation of the image reproduction device, and an acceleration or a vibration of the image reproducing device). At least one sensor of the sensor unit 60 may detect a state of the image reproducing device, generate a signal corresponding to the detection, and transmit the generated signal to the controller 10. The sensor of the sensor unit 60 may be added or removed according to performance of the image reproducing device.

Further, the image producing device may include a GPS module. The GPS module may receive radio waves from a plurality of GPS satellites (not shown) in orbit around the Earth, and calculate a position of the image reproducing device by using a time of arrival of the radio waves from the GPS satellites (not shown) to the image reproducing device.

The multiscreen image system according to the present invention may be described based on a UPnP Audio/Video (AV) architecture. FIG. 2 illustrates a UPnP AV playback structure to which the present invention is applied. A role of each component will be described below.

The control point 100 serves to manage and control all of the UPnP devices. When a request is received from a user through a user interface or an event is generated, the control point 100 transmits a command (UPnP action) to other UPnP constituent elements, for example, the media server 200 or the media renderer 300. The constituent element receiving the command performs a command, and transmits a result response for the performance to the controller point 100.

The media server 200 is a transmission or transfer server for managing media or content. The media server 200 may include a content directory service 210 including a function of browsing possessed media or searching for a specific media, and a connection manager service 220 for managing a connection with another UPnP device, and may include an AV transport service for controlling (for example, playing, stopping, pausing, and seeking) the media transmission to another UPnP device as necessary.

The media renderer 300 is a transmission or transfer client for reproducing media or contents received from another UPnP device. The media renderer 300 includes a rendering control service 310 for controlling (for example, controlling brightness, contrast, volume, and mute) media reproduction, and a connection manager service 320 for managing a connection with another UPnP device, and may include an AV transport service 330 for controlling (for example, playing, stopping, pausing, and seeking) the media transmission to another UPnP device as necessary, similar to the media server 200. The media renderer 300 may include a decoder for decoding the media.

Any image reproducing device may serve as each of the control point 100, the media server 200, and the media renderer 300 if the device is capable of performing a relevant function. For example, each of the television, the tablet PC, and the smart phone may be operated as one of the control point 100, the media server 200, and the media renderer 300 depending on a case.

The present invention may also be described based on a flowchart for reproducing the media in the UPnP AV. Accordingly, the flowchart for reproducing the media in the UPnP AV of FIG. 2 will be first described.

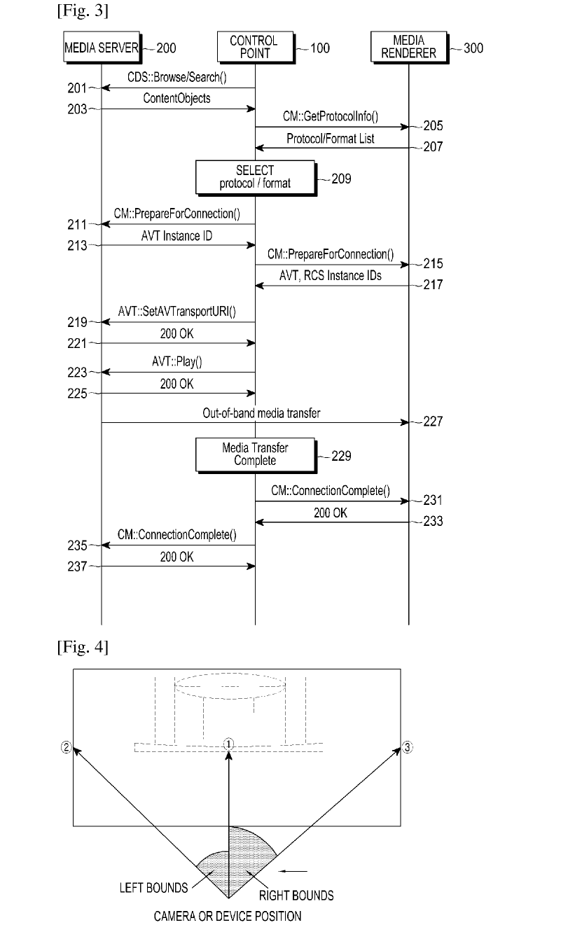

FIG. 3 is a diagram illustrating an operation process of the UPnP system.

In step 201, the control point 100 transmits a CDS::Browse( )/Search( ) command to a media server 200, and makes a request for browsing possessed media or content, or a request for searching for specific media or content to the media server 200. In step 203, the media server 200 transmits information and an access address (URI) about the requested media to the control point 100. The media or content may be an audio file, a video file, an audio/video file, or the like.

In step 205, the control point 100 transmits a CM::GetProtocolInfo( ) command to the media renderer 300, and makes a request for protocol or media format information supported by the media renderer 300. In step 207, the media renderer 300 transmits a corresponding protocol or format list to the control point 100.

In step 209, the control point 100 selects an optimum protocol or format in the received protocol or format list.

In step 211, the control point 100 transmits a CM::PrepareForConnection( ) command to the media server 200, notifies of information about the media render 300 (for example, a connection management service address, and a protocol to be used), and makes a request for preparing a connection with the media renderer 300. In step 213, the media server 200 transmits an AV Transport (AVT) ID or AVT instance ID for identifying the transmission of the media to the control point 100 after a completion of the preparation of the connection.

In step 215, the control point 100 transmits the CM::PrepareForConnection( ) command to the media renderer 300, notifies of the information about the media server 200 (for example, the connection management service address, and the protocol to be used), and makes a request for preparing a connection with the media server 200. In step 217, the media server 300 transmits the AV Transport ID or AVT instance ID for identifying the transmission of the media and a Rendering Control Service (RCS) ID or RCS instance ID for identifying the reproduction of the received media to the control point 100 after a completion of the preparation of the connection.

In step 219, the control point 100 transmits a AVT::SetAVTransportURI( ) command to the media server 200, and selects and notifies of an address or a URI of media to be transmitted to the media renderer 300. The address of the media is received by the control point 100 in step 203. In step 221, the media server 200 transmits a 200 OK response indicating that the command is received and is to be performed to the control point 100.

In step 223, the control point 100 transmits an AVT::Play( ) command to the server 200, and instructs the media server 200 to transmit the selected media to the media renderer 300 so as to reproduce the selected media. In step 225, the media server 200 transmits a 200 OK response indicating that the command is received and is to be performed to the control point 100.

In steps 219 to 225, a push method of directly transmitting, by the media server 200, media to be reproduced by the media renderer 300 without the request of the media renderer 300 is assumed. However, a pull method of first making a request for a media to be reproduced by the media renderer 300 and transmitting the media by the media server 200 is available. In this case, steps 219 to 225 are performed between the control point 100 and the media renderer or between the media server 200 and the media renderer 300, instead of between the control point 100 and the media server 200.

In step 227, the media server 200 transmits the designated media to the media renderer 300.

When it is confirmed that the transmission of the media is completed in step 229, the control point 100 transmits a CM::ConnectionComplete( ) command to the media renderer 300, and notifies the media render 300 of a termination of the connection in step 231. In step 233, the media server 300 transmits a 200 OK response indicating that the command is received to the control point 100.

Similarly, the control point 100 transmits a CM::ConnectionComplete( ) command to the media server 200 and notifies the media server 200 of a termination of the connection in step 235, and the media server 200 transmits a 200 OK response indicating that the command is received to the control point 100 in step 237.

In the present invention, in order to recognize view points of the devices (view points displayed by device screens or display units of the devices), the control point 100 transmits a new command, for example, a CM::GetviewPoint( ) command, for making a request for view point information to the media renderer 300. The control point 100 may receive information represented in Table 1 below as a response to the request for the view point information.

TABLE 1

| Related State Variable | Direction |
|---|---|
| Position information (PositionInfo) | OUT |
| Orientation information (OrientationInfo) | OUT |
| Zoom setting information (ZoomInfo) | OUT |

The view point information may include at least one of position information (PositionInfo), orientation information (OrientationInfo) and zoom setting information (ZoomInfo).

Position information (PositionInfo) is information representing a position of the media render 300. This information is formed of, for example, X, Y, and Z positions, and may be represented by CSV(float) (Comma Separated List, floating point number; for example, “2.4, 48.6, −25.3”). The orientation information (OrientationInfo) includes information representing an orientation or angles at which the media renderer 300 views the media from the position. The orientation information is formed or heading, elevation, and bank directions, (or yaw, pitch, and roll), and may be displayed by CVS(int) (Comma Separated List, integer number; for example, “270, −45, 355”). The zoom setting information (ZoomInfo) is information representing a zoom ratio of a view displayed by the media renderer 300, and may be represented as a zoom factor. For example, when a value of the zoom setting information is “1”, the media renderer 300 displays the view without the zoom, i.e., with an original size, and when a value of the zoom setting information is “2”, the media renderer 300 displays the view with the double zoom. When the view point is first requested from the media renderer 300, there is no displayed view, so that the value of the zoom setting information is set to “1”.

In the present invention, a range of an orientation is also set for every displayed view. The orientation bounds (upnp::orientation_bounds) represent orientation bounds of a view, and may be represented with left orientation bounds of the view, right orientation bounds of the view, top orientation bounds of the view, and bottom orientation bounds of the view. The orientation bounds (upnp::orientation_bounds) may represent orientation bounds of a view which can be photographed by a camera of the media renderer 300.

The left orientation bounds (upnp:orientation_bound_left) of the view, and the right orientation bounds (upnp:orientation_bound_right) of the view set the left orientation bounds and the right orientation bounds of the displayed view. For example, upnp:orientation_bound_left=40° (N) and upnp:orientation_bound_right=60° (N).

The top orientation bounds (upnp:orientation_bound_top) of the view and the bottom orientation bounds (upnp:orientation_bound_bottom) of the view set the top orientation bounds and the bottom orientation bounds of the displayed view.

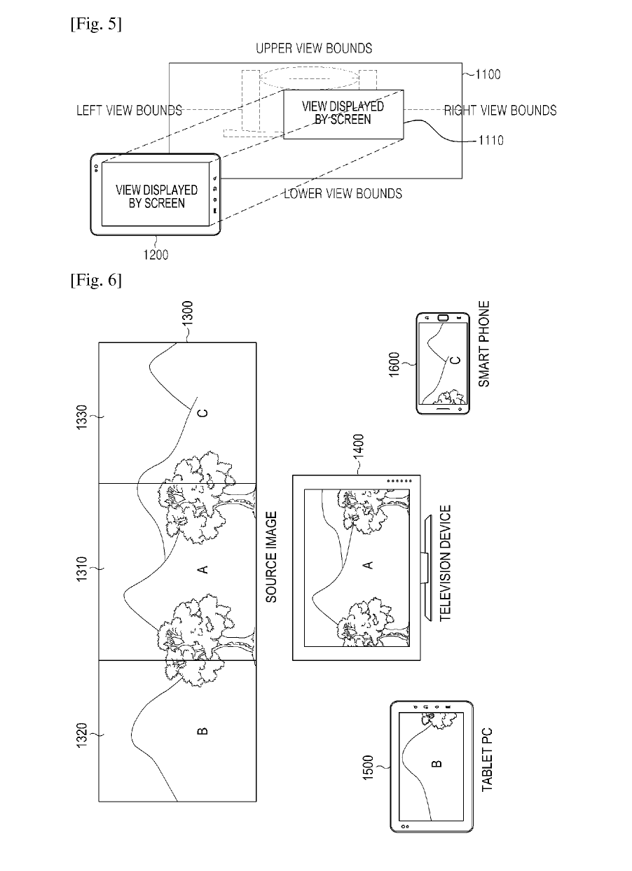

The bounds as described above imply angles which a left boundary, a right boundary, a top boundary, and a bottom boundary of the displayed view make with respect to the center, respectively. FIG. 4 illustrates upnp:orientation_bound_left \textcircled{2} and upnp:orientation_bound_right \textcircled{3} based on the center \textcircled{1}. The upnp:orientation_bound_top and upnp:orientation_bound_bottom are set in accordance with a vertical direction with the same reference.

In the present invention, a position, an orientation (direction), or a zoom factor are recognized, which are set in the device to display the media based on the view point information including at least one of the position information (PositionInfo), the orientation information (OrientationInfo), and the zoom setting information (ZoomInfo) of the device, and further, when a size of the screen of the device is recognized (in the present invention, it is assumed that the information is preliminarily recognized), the bounds displayed by the screen may be found. The bounds may also be divided into left bounds, right bounds, top bounds, and bottom bounds, and changed according to a movement of the view point of the screen in real time. The screen bounds are compared with the organized view bounds (upnp::orientation_bounds) to investigate whether the screen bounds exceeds the view bounds. This is represented in FIG. 5. In FIG. 5, a whole view 1100 represents view bounds of an actually photographed image, and a renderer view 1110 represents bounds of a view displayed on the screen of the image reproducing device 1200. The renderer view 1110 of the image reproducing device 1200 may be within a top view boundary, a left view boundary, a right view boundary, and a bottom view boundary of the whole view 1100.

Whether the bounds displayed by the screen exceed the view bounds is defined through a state variable ViewoutOfBound as follows.

TABLE 2

| Related State Variable | Direction | Evented |
|---|---|---|
| ViewoutOfBound | OUT | YES |

ViewoutOfBound is a Boolean, so when the screen bounds are within the view bounds, ViewoutOfBound is “0”, and when the screen bounds exceed the view bounds, ViewoutOfBound is “1”. “YES” of Evented means transmission of an event notifying of a change to a requesting constituent element whenever the value of ViewOutOfBound is changed. That is, in the present invention, the control point 100 transmits a corresponding view to the media renderer 300, and then registers a change in the value of ViewOutOfBound.

In the present invention, a system for displaying an image through two or more receiving devices is provided. Accordingly, the media renderers are present in equal number to the number of receiving devices. Further, one device among the receiving devices serves as a reference device. This is represented in FIG. 6. For example, when it is assumed that there are three devices, a television 1400, a smart phone 1600, and a tablet PC 1500, the television 1400 first receives the entire views 1300, and a user first selects a view to be displayed by the television 1400, the television 1400 is the reference device. Views displayed by the remaining devices are adjusted according to the view selected by the reference device. For example, when it is assumed that there are three devices, the television 1400, the smart phone 1600, the tablet PC 1500, and there are three views, that is, the left view 1320, the center view 1310, and the right view 1320, and when the user selects the display of the center view 1310 on the television that is the reference device, a right view 1330 is displayed on a second device, that is, the smart phone 1600, at the right side of the reference device, in order to display continuity of the view. Then, a left view 1320 is displayed on a third device, that is, the tablet PC 1500, at the left side of the reference device.

However, when the user selects the display of the left view 1320 on the television 1400 that is the reference device, the center view 1310, rather than the right view 1330, is displayed on the smart phone 1600 at the right side of the reference device in order to display continuity of the view.

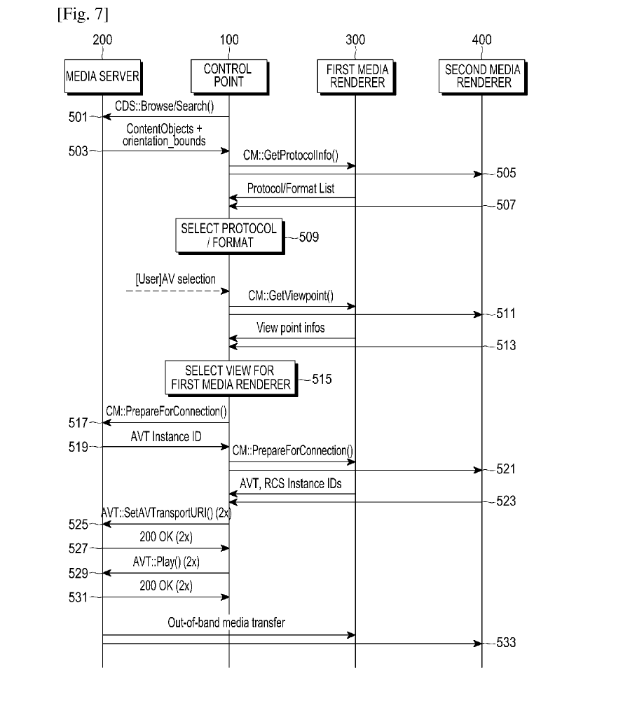

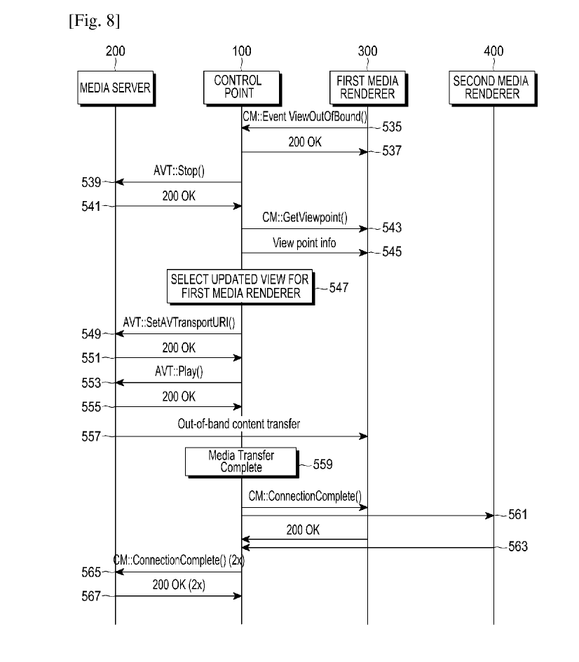

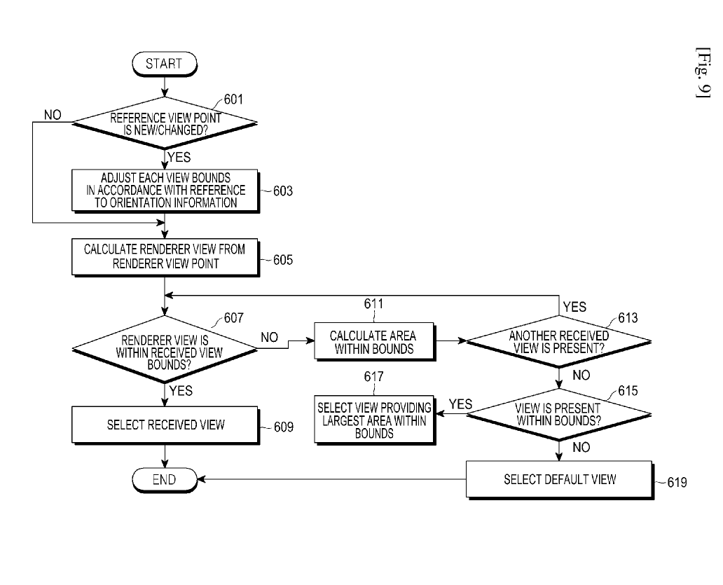

In FIGS. 7 and 8, flowcharts employing the present invention will be described based on the existing flowchart described in FIG. 3. In FIGS. 7 and 8, and the description thereof, in order to discriminate between the reference device and a general device, the aforementioned media renderer 300 is referred to as a first media renderer 300, and the media renderer serving as the reference device is referred to as a second media renderer 400.

In step 501, the control point 100 transmits a CDS::Browse( )/Search( ) command to the media server 200, and makes a request for browsing possessed media or searching for a specific media to the media server 200. In step 503, the media server 200 transmits information and an access address (URI) about the requested media to the control point 100. In this case, the present invention and the existing technology are different in that a value of upnp::orientation-bounds including the aforementioned view bounds is transmitted along with each media to be transmitted.

Steps 505 to 509 are the same as those of steps 205 to 209 described in FIG. 3.

When a user selects a reference view desired to be viewed, the control point 100 transmits a CM::GetViewpointInfo( ) command to the first media renderer 300 and the second media renderer 400 and makes a request for view point information. In step 513, the first media renderer 300 and the second media renderer 400 transmit the aforementioned information about the view point to the control point 100.

In step 515, the control point 100 selects a view appropriate to the first media renderer 300 by comparing the received view points and the received upnp::orientation_bounds information. The control point 100 may transmit the received upnp::orientation_bounds information to each of the first media renderer 300 and the second media renderer 400 along with a CM::PrepareForConnection( ) command in step 521.

Steps 517 to 533 are the same as those of steps 211 to 227 described in FIG. 3. The control point 100 transmits a AVT::SetAVTransportURI( ) command to the media server 200 in step 525. The AVT::SetAVTransportURI( ) command includes a URI appropriate to the view selected in step 515. Further, steps 521, 523, and 533 are equally performed on each of the first media renderer 300 and the second media renderer 400.

When a screen view displayed by the first media renderer 300 gets out of the view bounds transmitted by the control point 100, the first media renderer 300 notifies the control point 100 of the fact that the screen view displayed by the first media renderer 300 gets out of the view bounds by transmitting CM::Event ViewOutOfBound( ) to the control point 100 in step 535. In step 537, the control point 100 transmits a 200 OK response indicating that an event is received to the first media renderer 300.

In step 539, the control point 100 instructs a stopping of the transmission of the view to the media renderer 300 by transmitting AVT::Stop( ) to the media server 200. In step 541, the media server 200 transmits a 200 OK response indicating that the command is performed to the control point 100.

The control point 100 makes a request for information about the changed view point to the first media renderer 300 in step 543, and the first media renderer 300 transmits the requested view point information to the control point 100 in step 545.

In step 547, the control point 100 newly selects a view appropriate to the first media renderer 300 by comparing the received information about the view point with already possessed view point information of the second media renderer 400 and information about available view bounds (upnp::orientation_bounds).

Steps 549 to 567 are the same as those of steps 219 to 237 described in FIG. 3. The control point 100 transmits a AVT::SetAVTransportURI( ) command to the media server 200 in step 549. The AVT::SetAVTransportURI( ) command includes a URI appropriate to the view selected in step 547. Further, steps 561 and 563 are equally performed on each of the first media renderer 300 and the second media renderer 400.

FIG. 9 describes steps 515 and 547 described with reference to FIGS. 7 and 8 as the operation of the control point 100 in detail.

In step 601, the control point 100 checks whether new view point information or changed view point information is received from the second media renderer 400. When the new/changed view point information is received, the process proceeds to step 603, and when the new/changed view point information is not received, the process proceeds to step 605.

In step 603, the control point 300 adjusts (offsets) bounds of each received view based on the orientation information (OrientationInfo) included in the view point information received from the second media renderer 400. Since the view displayed to the first media renderer 300 is determined based on the view displayed to the media renderer 400 as already described above, the right view or the left view with respect to the view of the second media renderer 400, and the received view bounds need to be adjusted in accordance with the view point of the second media renderer 400.

For example, it is assumed that an actual photographing direction of the center view is 0° (N), and left-right bounds are 340° (N) and 20° (N), respectively. When it is assumed that a view selected by the second media renderer 400 is a center view, and an orientation is 180° (S), the view faces in an opposite direction to the actual photographing direction. Accordingly, the left-right bounds of the center view are adjusted to 160° (S) and 200° (S) in accordance with the orientation of 180° (S) of the second media renderer 400.

In step 605, the control point 100 calculates bounds of a view, that is, a renderer view, to be actually displayed through the first media renderer 300 based on view point information, that is, the position information (PositionInfo), the orientation information (OrientationInfo), and the zoom setting information (ZoomInfo), received from the first media renderer 300 as described with reference to FIG. 5, and the process proceeds to step 607.

In step 607, the control point 100 checks whether the renderer view are included in bounds of the received view. When the renderer view are included in bounds of the received view, the process proceeds to step 609, and when the renderer view are not included in bounds of the received view, the process proceeds to step 611.

In step 609, the control point 100 selects the renderer view as a renderer view to be provided to the first media renderer, and then the operation is terminated.

In step 611, when the calculated render view are not included in the bounds of the received view in step 611, the control point 100 calculates an area of the render view included in the bounds, and the process proceeds to step 613.

When another view received by the receiving system is left in step 613, the process proceeds to step 607, and when there is no view received by the receiving system in step 613, the process proceeds to step 615.

In step 615, when the renderer view are partially included within the bounds of one or more views among the received views, that is, when the number of cases where the area calculated in step 611 is larger than 0 is at least one, the process proceeds to step 617, and when the renderer view are not included within the bounds of at least one view among the received views, the process proceeds to step 619.

In step 617, the control point 100 selects a view including the largest area of the renderer view among the received views as a final renderer view to be provided to the media renderer 300, and the operation is terminated.

In step 619, since the renderer view is not included in any received view, the control point 100 selects an already selected default view as a final renderer view to be provided to the first media renderer 300, and the operation is terminated. For example, the default view may be a black screen having no contents, or the same view as the view provided to the second media renderer 400.

While the present invention has been shown and described with reference to certain embodiments thereof, it will be understood by those skilled in the art that various changes in form and details may be made therein without departing from the spirit and scope of the present invention as defined by the appended claims.

1. A method of providing an image through a plurality of image reproducing devices by a control point device, the method comprising:
collecting view point information from the plurality of image reproducing devices;
recognizing a position of each of the plurality of image reproducing devices based on the view point information, and determining a corresponding renderer view and a corresponding divided image of a whole image to be provided in correspondence with the position of each of the plurality of image reproducing devices; and
providing the corresponding divided image corresponding to the corresponding renderer view to each of the plurality of image reproducing devices.

2. The method of claim 1, wherein determining the corresponding renderer view comprises:
determining a first image reproducing device as a reference device among the plurality of image reproducing devices;
determining a first divided image of the whole image corresponding to a first renderer view to be provided to the first image reproducing device;
recognizing a relative position of a second image reproducing device among the plurality of image reproducing devices based on the reference device;
determining a second renderer view corresponding to the second image reproducing device based on the first divided image and the relative position of the second image reproducing device; and
determining a second divided image of the whole image corresponding to the determined second renderer view.

3. The method of claim 1, wherein the view point information includes at least one of position information, orientation information, and zoom setting information of each of the plurality of image reproducing devices.

4. The method of claim 3, wherein the orientation information is information representing a display orientation of a corresponding image reproducing device at a position of the corresponding image reproducing device.

5. The method of claim 3, further comprising collecting a change in a position of each of the plurality of image reproducing devices in real time, and updating a relevant renderer view.

6. A control point device for providing an image through a plurality of image reproducing devices, comprising:
a communication unit that performs communication with the plurality of image reproducing devices; and
a controller that collects view point information from the plurality of image reproducing devices through the communication unit, recognizes a position of each of the plurality of image reproducing devices based on the view point information, determines a corresponding renderer view and a corresponding divided image of a whole image to be provided in correspondence with a position of each of the plurality of image reproducing devices, and provides a corresponding divided image corresponding to a corresponding renderer view to each of the plurality of image reproducing devices.

7. The control point device of claim 6, wherein in order to determine the corresponding renderer view, the controller determines a first image reproducing device as a reference device among the plurality of image reproducing devices, determines a first divided image of the whole image corresponding to a first renderer view to be provided to the first image reproducing device, recognizes a relative position of a second image reproducing device among the plurality of image reproducing devices based on the reference device, determines a second renderer view corresponding to the second image reproducing device based on the first divided image and the relative position of the second image reproducing device, and determines a second divided image of the whole image corresponding to the determined second renderer view.

8. The control point device of claim 6, wherein the view point information includes at least one of position information, orientation information, and zoom setting information of each of the plurality of image reproducing devices.

9. The control point device of claim 8, wherein the orientation information is information representing a display orientation of a corresponding image reproducing device at a position of the corresponding image reproducing device.

10. The control point device of claim 8, wherein the controller collects a change in a position of each of the plurality of image reproducing devices in real time, and updates a relevant renderer view.
